(19) United States
(12) Patent Application Publication
(10) Pub. No.: US 2025/0030523 A1
(43) Pub. Date: Jan. 23, 2025

(54) CONTROL SIGNALLING

(71) Applicant: Nokia Technologies OY, Espoo (FI)

(72) Inventors: Karthik UPADHYA, Espoo (FI); Paolo BARACCA, Munich (DE); Andrea BEDIN, Espoo (FI); Martti Johannes MOISIO, Espoo (FI); Mikko Aleksi UUSITALO, Espoo (FI)

(21) Appl. No.: 18/714,793

(22) PCT Filed: Dec. 15, 2021
(86) PCT No.: PCT/EP2021/085963

§ 371 Date: May 30, 2024

(51) Int. Cl. H04L 5/00; H04W 72/0446

(52) U.S. Cl. CPC H04L 5/0094; H04L 5/0005; H04W 72/0446

(57) ABSTRACT

The apparatus may collect location information of at least one user device at at least one time instant over a time interval, for each of the at least one user device: obtain an estimate of at least one parameter relating to the collected location information, generate by using the obtained estimate of the at least one parameter, at least one resource allocation parameter set each comprising at least one resource allocation parameter, wherein each of the at least one resource allocation parameter set is associated with corresponding one of the at least one time instant, generate a resource allocation configuration comprising the at least one resource allocation parameter set, and transmit the resource allocation configuration to the at least one user device. Apparatuses, methods, and computer programs are disclosed.

### FIELD OF THE INVENTION

The present application relates generally to control signalling. More specifically, the present application relates to low-overhead control signalling.

### BACKGROUND OF THE INVENTION

Control channels, like physical downlink control channel (PDCCH), physical uplink control channel (PUCCH) and physical broadcast channel (PBCH) are necessary components of a network. They play a key role in operations such as initial access, scheduling, channel measurements, and link adaptation. Signalling in the control channels may be however further improved to make them to operate in a more optimal way.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. The scope of protection sought for various embodiments of the present disclosure is set out by the independent claims.

Example embodiments of the present disclosure reduce control channel overhead and end-to-end latency by putting user devices (UEs) on a script through a radio-aware digital twin. This and other benefits may be achieved by the features of the independent claims. Further advantageous implementation forms are provided in the dependent claims, the description, and the drawings.

According to a first aspect, an apparatus may comprise at least one processor and at least one memory including computer program code, the at least one memory and the computer code configured to, with the at least one processor, cause the apparatus at least to: collect location information of at least one user device at at least one time instant over a time interval; for each of the at least one user device, obtain an estimate of at least one parameter relating to the collected location information; generate, by using the obtained estimate of the at least one parameter, at least one resource allocation parameter set each comprising at least one resource allocation parameter, wherein each of the at least one resource allocation parameter set is associated with corresponding one of the at least one time instant; generate a resource allocation configuration comprising the at least one resource allocation parameter set; and transmit the resource allocation configuration to the at least one user device.

According to an example embodiment of the first aspect, the computer code may be further configured to, with the at least one processor, cause the apparatus to: generate the at least one resource allocation parameter set by assigning resource allocation, and modulation and coding scheme adaptation over the time interval based at least on the obtained estimate of the at least one parameter.

According to an example embodiment of the first aspect, wherein the resource allocation configuration may comprise a frame number and/or a slot number corresponding to each of the at least one time instant.

According to an example embodiment of the first aspect, wherein the at least one resource allocation parameter comprises at least one of the following: an active bandwidth part, time allocation, frequency allocation, modulation and coding scheme, and/or antenna port related information.

According to an example embodiment of the first aspect, the computer code may be further configured to, with the at least one processor, cause the apparatus to: for each of the at least one user device, obtain link signal to interference plus noise ratio and/or channel quality indicator from measurements or the digital twin if the link signal to interference plus noise ratio and/or the channel quality indicator is higher than a predetermined threshold, transmit the at least one resource allocation parameter set in resource allocation configuration; and if the link signal to interference plus noise ratio and/or the channel quality indicator is equal or lower than the predetermined threshold, transmit the at least one resource allocation parameter set separately for each of the at least one time instant.

According to an example embodiment of the first aspect, wherein the estimate of the at least one parameter may be obtained using a digital twin.

According to an example embodiment of the first aspect, wherein the resource allocation configuration may comprise at least one default resource allocation parameter set and at least one alternative resource allocation parameter set, wherein each of the at least one default resource allocation parameter set and each of the at least one alternative resource allocation parameter set may be associated with the corresponding one of the at least one time instant over the time interval, each of the at least one default resource allocation parameter set may comprise the at least one resource allocation parameter, and each of the at least one alternative resource allocation parameter set may comprise the at least one resource allocation parameter.

According to an example embodiment of the first aspect, wherein the resource allocation configuration may comprise instructions indicating the at least one user device to: if values of local measurements at the at least one user device are within a predefined interval, perform data transmission and/or reception according to the at least one default resource allocation parameter set; and if the values of the local measurements at the at least one user device are outside the predefined interval, perform the data transmission and/or reception according to the at least one alternative resource allocation parameter set; or receive the at least one resource allocation parameter set separately at each of the at least one time instant.

According to an example embodiment of the first aspect, the local measurements may be obtained by the at least one user device over demodulation reference symbols within data transmitted in a physical downlink shared channel data.

According to an example embodiment of the first aspect, the predefined interval may be obtained from the digital twin as an estimate of a confidence interval on the obtained estimate of the at least one parameter.

According to an example embodiment of the first aspect, the obtained estimate of the at least one parameter may comprise at least one of the following: estimated channel statistics, channel quality indicator, signal to interference plus noise ratio, and/or transmit buffer status relating to the at least one time instant over the time interval for each of the at least one user device.

According to an example embodiment of the first aspect, the digital twin may be a radio-aware digital twin.

According to an example embodiment of the first aspect, wherein the at least one resource allocation parameter set may correspond to each of the at least one time instant is different.

According to an example embodiment of the first aspect, the resource allocation configuration may be transmitted to the at least one user device as an aggregate downlink control information or with higher layer signalling.

According to a second aspect, an apparatus may comprise at least one processor and at least one memory including computer program code, the at least one memory and the computer code configured to, with the at least one processor, cause the apparatus at least to: receive a resource allocation configuration from a network node, wherein the resource allocation configuration may comprise at least one resource allocation parameter set; perform data transmission and/or reception according to the at least one resource allocation parameter set comprising at least one resource allocation parameter, wherein each of the at least one resource allocation parameter set may be associated with corresponding one of at least one time instant over a time interval, wherein the at least one resource allocation parameter set may be generated by the network node using an estimate of at least one parameter, wherein the estimate of the at least one parameter may relate to location information of the apparatus collected at the at least one time instant over the time interval.

According to an example embodiment of the second aspect, wherein the resource allocation configuration may comprise at least one default resource allocation parameter set and at least one alternative resource allocation parameter set, wherein each of the at least one default resource allocation parameter set and each of the at least one alternative resource allocation parameter set may be associated with the corresponding one of the at least one time instant over the time interval, each of the at least one default resource allocation parameter set may comprise the at least one resource allocation parameter, and each of the at least one alternative resource allocation parameter set may comprise the at least one resource allocation parameter.

According to an example embodiment of the second aspect, wherein the resource allocation configuration may further comprise instructions indicating the apparatus to: if values of local measurements at the apparatus are within a predefined interval, perform the data transmission and/or reception according to the at least one default resource allocation parameter set; and if the values of the local measurements at the apparatus are outside the predefined interval, perform the data transmission and/or reception according to the at least one alternative resource allocation parameter set; or receive the at least one resource allocation parameter set separately at each of the at least one time instant.

According to an example embodiment of the second aspect, the local measurements may be obtained over demodulation reference symbols within data transmitted in a physical downlink shared channel.

According to an example embodiment of the second aspect, the at least one resource allocation parameter may comprise at least one of the following: an active bandwidth part, time allocation, frequency allocation, modulation and coding scheme, and/or antenna port related information.

According to an example embodiment of the second aspect, the resource allocation configuration may comprise a frame number and/or a slot number corresponding to each of the at least one time instant.

According to an example embodiment of the second aspect, wherein the estimate of the at least one parameter is obtained using a digital twin.

According to an example embodiment of the second aspect, wherein the at least one resource allocation parameter set corresponding to each of the at least one time instant is different.

According to a third aspect, a method may comprise: collecting at a network node, location information of at least one user device at at least one time instant over a time interval; for each of the at least one user device, obtaining an estimate of at least one parameter relating to the collected location information; generating, by using the obtained estimate of the at least one parameter, at least one resource allocation parameter set each comprising at least one resource allocation parameter, wherein each of the at least one resource allocation parameter set is associated with corresponding one of the at least one time instant; generating a resource allocation configuration comprising the at least one resource allocation parameter set; and transmitting the resource allocation configuration to the at least one user device.

According to an example embodiment of the third aspect, the method may further comprise: generating the at least one resource allocation parameter set by assigning resource allocation, and modulation and coding scheme adaptation over the time interval based at least on the obtained estimate of the at least one parameter.

According to an example embodiment of the third aspect, wherein the resource allocation configuration may comprise a frame number and/or a slot number corresponding to each of the at least one time instant.

According to an example embodiment of the third aspect, the at least one resource allocation parameter may comprise at least one of the following: an active bandwidth part, time allocation, frequency allocation, modulation and coding scheme, and/or antenna port related information.

According to an example embodiment of the third aspect, the method may further comprise: for each of the at least one user device, obtaining link signal to interference plus noise ratio and/or channel quality indicator from measurements or the digital twin; and if the link signal to interference plus noise ratio and/or the channel quality indicator is higher than a predetermined threshold, transmitting the at least one resource allocation parameter set in the resource allocation configuration; and if the link signal to interference plus noise ratio and/or the channel quality indicator is equal or lower than the predetermined threshold, transmitting the at least one resource allocation parameter set separately for each of the at least one time instant.

According to an example embodiment of the third aspect, wherein the estimate of the at least one parameter may be obtained using a digital twin.

According to an example embodiment of the third aspect, wherein the resource allocation configuration may comprise at least one default resource allocation parameter set and at least one alternative resource allocation parameter set, wherein each of the at least one default resource allocation parameter set and each of the at least one alternative resource allocation parameter set may be associated with the corresponding one of the at least one time instant over the time interval, each of the at least one default resource allocation parameter set may comprise the at least one resource allocation parameter, and each of the at least one alternative resource allocation parameter set may comprise the at least one resource allocation parameter.

According to an example embodiment of the third aspect, wherein the resource allocation configuration may further comprises instructions indicating the at least one user device to: if values of local measurements at the at least one user device are within a predefined interval, perform data transmission and/or reception according to the at least one default resource allocation parameter set; and if the values of the local measurements at the at least one user device are outside the predefined interval, perform the data transmission and/or reception according to the at least one alternative resource allocation: parameter set; or receive the at least one resource allocation parameter set separately at each of the at least one time instant.

According to an example embodiment of the third aspect, the local measurements may be obtained by the at least one user device over demodulation reference symbols within data transmitted over in a physical downlink shared channel.

According to an example embodiment of the third aspect, the predefined interval may be obtained from the digital twin as an estimate of a confidence interval on the obtained estimate of the at least one parameter.

According to an example embodiment of the third aspect, the obtained estimate of the at least one parameter may comprise at least one of the following: estimated channel statistics, channel quality indicator, signal to interference plus noise ratio, and/or transmit buffer status relating to the at least one time instant over the time interval for each of the at least one user device.

According to an example embodiment of the third aspect, the digital twin may be a radio-aware digital twin.

According to an example embodiment of the third aspect, wherein the at least one resource allocation parameter set corresponding to each of the at least one time instant is different.

According to an example embodiment of the third aspect, the resource allocation configuration may be transmitted to the at least one user device as an aggregate downlink control information or with higher layer signalling.

According to an example embodiment of a fourth aspect, a method may comprise: receiving at a user device, a resource allocation configuration from a network node, wherein the resource allocation configuration may comprise at least one resource allocation parameter set; and performing data transmission and/or reception according to the at least one resource allocation parameter set comprising at least one resource allocation parameter, wherein each of the at least one resource allocation parameter set may be associated with corresponding one of the at least one time instant over a time interval, wherein the at least one resource allocation parameter set may be generated by the network node using an estimate of at least one parameter, wherein the estimate of the at least one parameter may relate to location information of the apparatus collected at the at least one time instant over the time interval.

According to an example embodiment of the fourth aspect, the resource allocation configuration may comprise at least one default resource allocation parameter set and at least one alternative resource allocation parameter set, wherein each of the at least one default resource allocation parameter set and each of the at least one alternative resource allocation parameter set may be associated with the corresponding one of the at least one time instant over the time interval, each of the at least one default resource allocation parameter set may comprise the at least one resource allocation parameter, and each of the at least one alternative resource allocation parameter set may comprise the at least one resource allocation parameter.

According to an example embodiment of the fourth aspect, the resource allocation configuration may further comprise instructions indicating the user device to: if values of local measurements at the apparatus are within a predefined interval, perform the data transmission and/or reception according to the at least one default resource allocation parameter set; and if the values of the local measurements at the apparatus are outside the predefined interval, perform the data transmission and/or reception according to the at least one alternative resource allocation parameter set; or receive the at least one resource allocation parameter set separately at each of the at least one time instant.

According to an example embodiment of the fourth aspect, wherein the local measurements may be obtained over demodulation reference symbols within data transmitted in a physical downlink shared channel.

According to an example embodiment of the fourth aspect, the at least one resource allocation parameter may comprise at least one of the following: an active bandwidth part, time allocation, frequency allocation, modulation and coding scheme, and/or antenna port related information.

According to an example embodiment of the fourth aspect, the resource allocation configuration may comprise a frame number and/or a slot number corresponding to each of the at least one time instant.

According to an example embodiment of the fourth aspect, the estimate of the at least one parameter may be obtained using a digital twin.

According to an example embodiment of the fourth aspect, the at least one resource allocation parameter set may correspond to each of the at least one time instant is different.

According to an example embodiment of a fifth aspect, a computer program may comprise instructions for causing an apparatus to perform at least the following: collecting at a network node, location information of at least one user device at at least one time instant over a time interval; for each of the at least one user device, obtaining an estimate of at least one parameter relating to the collected location information; generating, by using the obtained estimate of the at least one parameter, at least one resource allocation parameter set each comprising at least one resource allocation parameter, wherein each of the at least one resource allocation parameter set may be associated with corresponding one of the at least one time instant; generating a resource allocation configuration comprising the at least one resource allocation parameter set; and transmitting the resource allocation configuration to the at least one user device.

According to an example embodiment of a sixth aspect, a computer program may comprise instructions for causing an apparatus to perform at least the following: receiving at a user device, a resource allocation configuration from a network node, wherein the resource allocation configuration may comprise at least one resource allocation parameter set; and performing data transmission and/or reception according to the at least one resource allocation parameter set comprising at least one resource allocation parameter, wherein each of the at least one resource allocation parameter set may be associated with corresponding one of at least one time instant over a time interval, wherein the at least one resource allocation parameter set may be generated by the network node using an estimate of at least one parameter, wherein the estimate of the at least one parameter may relate to location information of the apparatus collected at the at least one time instant over the time interval.

According to an example embodiment of a seventh aspect, an apparatus may comprise: means for collecting at a network node, location information of at least one user device at at least one time instant over a time interval; for each of the at least one user device, means for obtaining an estimate of at least one parameter relating to the collected location information; means for generating, by using the obtained estimate of the at least one parameter, at least one resource allocation parameter set each comprising at least one resource allocation parameter, wherein each of the at least one resource allocation parameter set may be associated with corresponding one of the at least one time instant; means for generating a resource allocation configuration comprising the at least one resource allocation parameter set; and means for transmitting the resource allocation configuration to the at least one user device.

According to an example embodiment of a eight aspect, an apparatus may comprise: means for receiving at a user device, a resource allocation configuration from a network node, wherein the resource allocation configuration may comprise at least one resource allocation parameter set; and means for performing data transmission and/or reception according to the at least one resource allocation parameter set comprising at least one resource allocation parameter, wherein each of the at least one resource allocation parameter set may be associated with corresponding one of at least one time instant over a time interval, wherein the at least one resource allocation parameter set may be generated by the network node using an estimate of at least one parameter, wherein the estimate of the at least one parameter may late to location information of the apparatus collected at the at least one time instant over the time interval.

### BRIEF DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 shows a part of an exemplifying radio access network in which examples of disclosed embodiments may be applied

FIG. 2 shows a block diagram of an example apparatus in which examples of the disclosed embodiments may be applied;

FIG. 3 illustrates an example of physical downlink control channel signalling, according to an example embodiment;

FIG. 4 illustrates an example of PDCCH signalling diagram incorporating aspects of the examples of the invention;

FIG. 5 illustrates an example method according to an example embodiment; and

FIG. 6 illustrates another example method according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps or operations for constructing and operating the example. However, the same or equivalent functions and sequences may be accomplished by different examples.

Example embodiments relate to a digital twin, the digital twin is a virtual replica of a physical asset or process that connects to and receives data from the latter. It monitors physical operations, controls the physical asset or process, tests what-if scenarios, predicts the future behavior of the physical operation or process, and supports decision-making. For example, a radio-aware digital twin, which may be used to put UEs on short term scripts where, given the UE trajectories over a time interval of T seconds and estimates of the transmit buffers of both a network and the UE in this duration, some of the radio parameters that are part of control signalling may be signalled in advance to the UEs

Example embodiments relate to an apparatus at a network side. The apparatus may comprise by an access point such as a base station.

According to an example embodiment, an apparatus at the network side is configured to collect location information and trajectory of at least one user device at at least one time instant over a time interval. The apparatus may also collect velocity components along three directions, i.e., the velocity along the x, y, and z axis. For each of the at least one user device the apparatus may obtain an estimate of at least one parameter relating to the collected location information. At least one resource allocation parameter set may be generated each comprising at least one resource allocation parameter by using the obtained estimate of the at least one parameter, wherein each of the at least one resource allocation parameter set is associated with corresponding one of the at least one time instant. More precisely, the apparatus may generate a resource allocation configuration (RAC) comprising the at least one resource allocation parameter set.

Finally, the apparatus may transmit the resource allocation configuration to the at least one user device. The resource allocation configuration may comprise for example, control messages about MCS, resource allocation, and power control. The transmission may be done as an aggregate DCI or with higher layer signalling.

In factories, extreme ultra-reliable low-latency communication (URLLC) may be expected to offer robust and dependable (in terms of communication service availability) wireless communication for industrial URLLC in a future factory environment with machine-type traffic for automated guided vehicles (AGVs), unmanned aerial vehicles (UAVs), robotic arms, etc. These future industrial environments may control and optimize operations through digital twins, where physical assets may have a virtual/digital representation, and 6G may play an important role in keeping the digital twins up-to-date. Typical parameters that may be modelled digitally are for example, position and orientation, temperature, pressure, and lubricant level and quality. These parameters may then be used to optimize operations in a factory floor and order maintenance.

One digital twin may be a radio-aware digital twin that may model radio conditions at a user device (UE) and base station (BS). Thus, it may model received signal and interference levels, channel conditions, etc. The digital twin may map UE and interferer locations, transmit powers and propagation conditions into link signal to noise plus interference ratio (SINR) potentially reducing the overhead required for resource allocation, scheduling, modulation, and coding scheme (MCS) adaptation, etc. A model may be suitable for scenarios where UE mobility may be controlled with known trajectories to predict the radio conditions at certain point in time over a certain bandwidth for every node in the system, both UE and BS. Using the digital twins in industrial scenarios is an active research topic also in 6G research.

Control channels, namely the physical downlink control channel (PDCCH), physical uplink control channel (PUCCH), and the physical broadcast channel (PBCH) may be necessary components of a network. They may play a key role in operations such as initial access, scheduling, channel measurements, and link adaptation, but may be one of the main sources of network overhead and reduce the overall achievable spectral efficiency.

These control channels may be designed for human-centric networks such as voice, video, etc., and may need to work seamlessly over a large geographical area in a variety of propagation scenarios like urban, rural, hilly terrain, etc. For instance, in an extreme case, the control signalling may need to be such that a phone turned off in one continent may work when turned on in another continent.

Characteristics of such a human-centric design may be low MCS, wherein each control message may use a code with low code-rate/high redundancy and transmit with quadrature phase-shift keying (QPSK) modulation for maximum reliability. This may be because the radio conditions may vary considerably in a human-centric network and since these control signals may be decodable by every UE in every possible location in the cell (in the case of group paging or broadcast), a worst-case design approach may be adopted.

Another characteristic may be frequent transmission, wherein periodicity with which control signals may be transmitted may depend on the rate at which the situation between the UE and the network changes. For instance, a UE travelling at a high velocity in arbitrary directions in an uncontrolled and unpredictable environment may experience a rapidly changing channel and may require frequent reallocation of time-frequency resources, modification of transmit power control parameters, continuous monitoring of channel quality, etc. necessitating frequent transmission of control signaling. Furthermore, the difficult to predict nature of human-generated traffic may require frequent changes in resource allocation/scheduling and slot format in the case of time-division duplexing (TDD).

Above mentioned characteristics may reduce overall network spectral efficiency and increase latency, not only by the transmission of control signalling, but also through dedicated signals such as sounding reference signals (SRS) and channel state information reference signals (CSI-RS) for measurements required for resource allocation and scheduling. Another source of latency may be the processing time incurred at the UE in decoding the control signals.

In the following, different exemplifying embodiments will be described using, as an example of an access architecture to which the embodiments may be applied, a radio access architecture based on long term evolution advanced (LTE Advanced, LTE-A), new radio (NR, 5G), or 6G without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS), or any combination thereof.

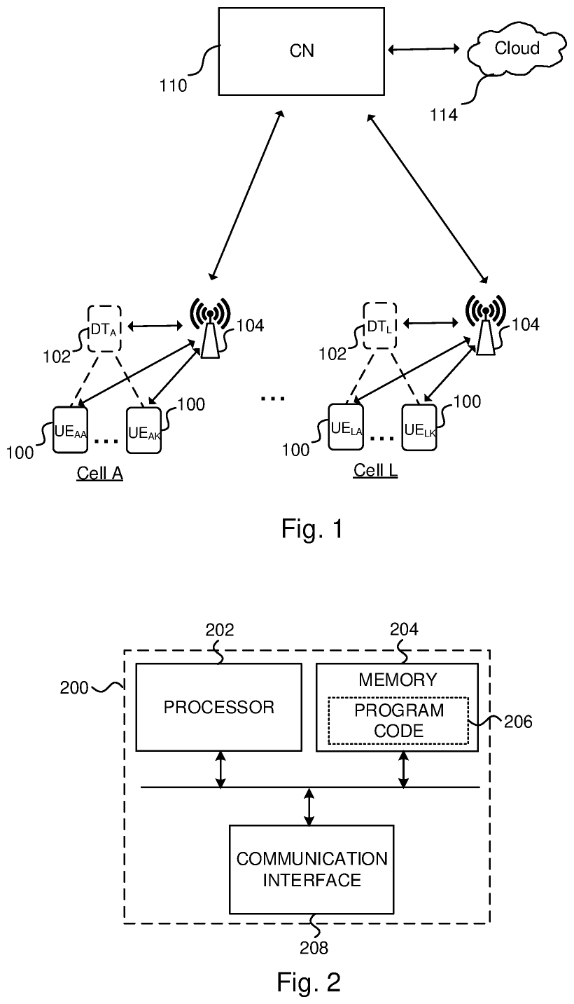

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 configured to be in a wireless connection on one or more communication channels in a cell with an access node (such as (e/g) NodeB) 104 providing the cell. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node, host, server or access point etc. entity suitable for such a usage.

The radio access network may comprise cells from A to L, user devices from A to K in each cell and may use the tuple ( [symbol] , k) to denote the k^{th} UE in the [symbol] ^{th} cell. The radio access network comprises also a digital twin 102 for example, a radio-aware digital twin in each cell from A to K.

A communications system may comprise more than one (e/g) NodeB in which case the (e/g) NodeBs may also be configured to communicate with one another over links, wired or wireless, designed for the purpose. These links may be used not only for signalling purposes but also for routing data from one (e/g) NodeB to another. The (e/g) NodeB is a computing device configured to control the radio resources of communication system it is coupled to. The (e/g) NodeB may also be referred to as a base station, an access point, an access node, a network node, or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device refers, for example, to a wireless mobile communication device operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, navigation device, vehicle infotainment system, and multimedia device, or any combination thereof. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

A wireless device is a generic term that encompasses both the access node and the terminal device.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of content delivery use cases and related applications including, for example, video streaming, audio streaming, augmented reality, gaming, map data, different ways of data sharing and various forms of machine type applications (such as (massive) machine-type communications (mMTC), including vehicular safety, different sensors and real-time control. 5G is expected to have multiple radio interfaces, namely below 6 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G may support both inter-RAT operability (such as LTE-5G) and inter-RI operability (inter-radio interface operability, such as below 6 GHZ-cmWave, below 6 GHZ-cmWave-mmWave). One of the concepts to be used in 5G networks may be network slicing in which multiple independent and dedicated virtual subnetworks (network instances) may be created within the same infrastructure to run services that have different requirements on latency, reliability, throughput and mobility.

The current architecture in LTE networks is fully distributed in the radio and fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU) and nonreal time functions being carried out in a centralized manner (in a centralized unit, CU).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. A cellular radio system may be implemented as a multilayer network including several kinds of cells. In multilayer networks, one access node provides one kind of a cell or cells, and thus a plurality of (e/g) NodeBs are required to provide such a network structure.

6G may be built on top of 5G in terms of many of the technological and use case aspects, which may drive their adoption at scale through optimization and cost-reduction. At the same time, 6G may enable new use cases. It may connect the physical world to our own human world, thanks to the massive scale deployment of sensors and artificial intelligence and machine learning (AI/ML) with digital twin models and real-time synchronous updates. These digital twin models may be crucial because they may allow to analyze what's happening in the physical world, simulate possible outcomes, anticipate needs, and then take productive actions back into the physical world. The digital twin models may already be used with 5G. With 6G, we may expect these technologies to operate at a much larger scale. The digital twins may be found not only in factories but also in wide area networks of cities and even digital twins of humans which will have a major impact on the network architecture.

Industrial networks, especially in the case of fully-automated factories, may be drastically different from human-centric networks. When the traffic may be primarily machine-to-machine, network operation may be restricted to a small geographical area such as a factory or port. In such a situation there may be available reasonably accurate location and orientation information for mobile UEs 100, predictable uplink/downlink (UL/DL) traffic patterns (except for aperiodic traffic such as alarms), controlled or partially controlled environment that may be designed from scratch taking radio conditions into account in a greenfield setup, and ability to control and plan UE trajectories. It may also be reasonable to expect the presence of a radio-aware digital twin 102. The digital twin 102 may know of the radio conditions experienced by the UEs 100 and the network. Since much of a machine-type traffic has a predictable traffic pattern, such a digital twin 102 may also have estimates of the amount of data in network/UE transmit buffers.

FIG. 2 is a block diagram depicting an apparatus 200 operating in accordance with an example embodiment. The apparatus 200 may be, for example, an electronic device such as a chip, chip-set, an electronic device, network node, or a network function. In general, the apparatus 200 may be configured to perform one or more network functions, for example according to the service-based architecture (SBA) of the 5th generation (5G) 3GPP standards. The apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware (HW) accelerator, a special-purpose computer chip, or the like.

The apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable the apparatus to send and/or receive information, for example the network management related information described herein to/from other network devices, nodes, or functions. For example, the apparatus 200 may use the communication interface 208 to send or receive information over the service-based interface (SBI) message bus of the 5G SBA. The communication interface 208 may be therefore used for internal communications within the apparatus or for external communications with other devices.

When the apparatus 200 is configured to implement some functionality, some component and/or components of the apparatus 200, such as for example the at least one processor 202 and/or the at least one memory 204, may be configured to implement this functionality. Furthermore, when the at least one processor 202 is configured to implement some functionality, this functionality may be implemented using the program code 206 comprised, for example, in the at least one memory 204.

The functionality described herein may be performed, at least in part, by one or more computer program product components such as software components. According to an embodiment, the apparatus comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUS).

The apparatus 200 comprises means for performing at least one example embodiment described herein. In one example, the means comprises the at least one processor 202, the at least one memory 204 including program code 206 configured to, when executed by the at least one processor, cause the apparatus 200 to perform the example embodiment(s).

The apparatus 200 may comprise for example a computing device such as for example a server. Although apparatus 200 is illustrated as a single device it is appreciated that, wherever applicable, functions of the apparatus 200 may be distributed to a plurality of devices, for example to implement example embodiments as a cloud computing service.

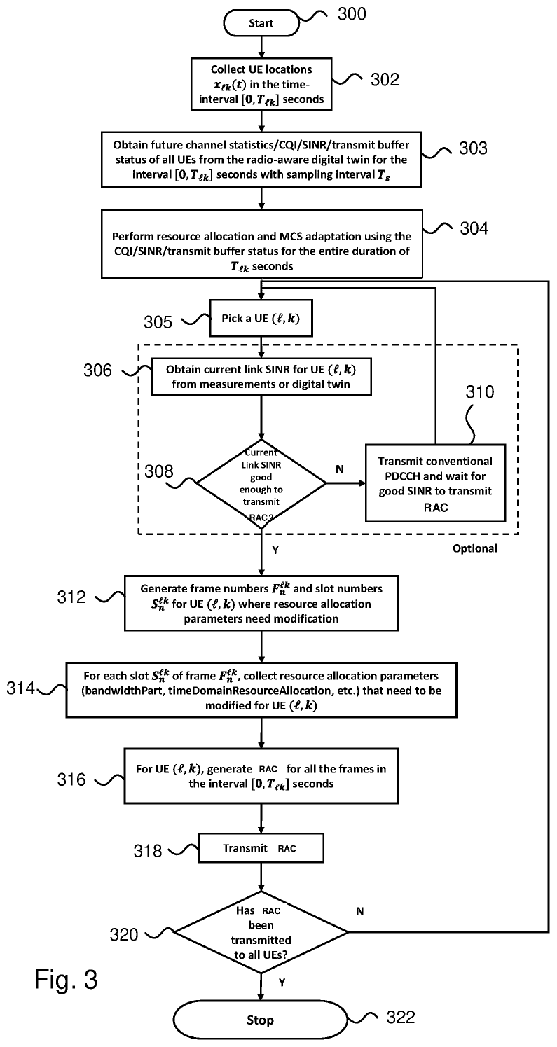

FIG. 3 illustrates an example of physical downlink control channel signalling, according to an example embodiment.

It shows a flow chart of signalling that may be executed by the apparatus 200, for example the network node 104.

According to an example embodiment, a method for optimizing network operation comprises putting a UE 100 on a resource allocation configuration (RAC) through a digital twin 102 for example, a radio-aware digital twin. The resource allocation configuration may comprise for example, control messages about MCS, resource allocation, and power control transmitted once for multiple time instants.

According to the example embodiment, given the time-interval T and time instants t₀, t₁, . . . , t_{N}, the UEs 100 may be given a single resource allocation configuration that may be a single control message that may look like
At t₀ switch to bandwidth part (BWP) B₀ and transmit on PRB D₀ with power control coefficients α and P0 and MCS M₀
At t₁ switch to BWP B₁ and receive on PRB D₁ and receive data with MCS M₁
. . .

According to the example embodiment, a single control message, or the single resource allocation configuration, is transmitted with a higher MCS than the one typically used for signalling. This is because an estimate of the UEs channel quality is available from the digital twin 102.

According to an example embodiment, control channel overhead and end-to-end latency is reduced by putting UEs on a resource allocation configuration through a digital twin 102. Also, estimates of the UL/DL transmit buffers at the UE/network provided by the digital twin 102 to pre-emptively schedule resources may be utilized. In PDCCH and PUCCH, control messages for parameters such as resource allocation, power control, MCS, etc. corresponding to multiple time-stamps may be transmitted once. Without using the resource allocation configuration in PDCCH and PUCCH, a parameter setting corresponding to only a single time-instant may be transmitted and changing this parameter will require PDCCH/PUCCH to be transmitted again.

According to an example embodiment, a network according to FIG. 1 may be used with cells from A to L and UEs 100 from A to K in each cell and use the tuple ( [symbol] , k) to denote the k^{th} UE in the [symbol] ^{th} cell. [symbol] (t) may be denoted as the 3D position of UE ( [symbol] ,k) at the t^{th} time instant.

At operation 300, the process may start. At operation 302, the apparatus 200 may collect UE ( [symbol] , k) 100 location information [symbol] (t) in the time-interval [0, [symbol] ] seconds. The UE 100 may be expected to follow a certain trajectory over a time interval of [symbol] seconds and that the location [symbol] (t) at the t^{th} time instant (where 0≤t≤ [symbol] ) may be known to the network a priori. The apparatus 200 may collect all UE 100 location information and trajectories for the next [0, [symbol] ] seconds. The UEs 100 may be unmanned ground or aerial vehicles and the trajectory information may be available.

According to an example embodiment, the apparatus 200 obtains an estimate of at least one parameter relating to the collected location information in the at least one time instant t over the time interval T for each of the at least one user device 100 through a digital twin 102. At operation 303, the apparatus may obtain future channel statistics/CQI/SINR/transmit buffer status of all UEs 100 from the digital twin 102 for the interval [0, [symbol] ] seconds with sampling interval Tₛ. According to an example embodiment, given the current and future positions of all LK UEs 100, the radio-aware digital twin [symbol] 102 may generate the estimate of at least one following parameter for UE ( [symbol] ,k) over the time-interval [symbol] seconds for a certain physical resource block (PRB) without explicit measurements or reference signals:
the second order statistics of a channel, wherein the channel means [symbol] (t); and spatial covariance matrix [symbol] (t) for UE ( [symbol] , k) at time instant t;
the link SINR on PRB p, which may comprise an estimate of a confidence interval, that may allow computing channel quality indicator (CQI); and/or
an estimate of the number of bits in the UE transmit buffers at time instant t denoted as pₜ(n) which may be a probability that the UE 100 has n bits to transmit at time t.

The estimate of the at least one parameter may be obtained using past measurements and also from deterministic methods such as ray tracing.

According to an example embodiment, the apparatus 200 generates at least one resource allocation parameter set for each of the at least one user device 100 over the time interval T by using the obtained estimate of the at least one parameter from the digital twin 102, wherein the at least one resource allocation parameter set is associated with corresponding one of the at least one time instant t, and each of the at least one resource allocation parameter set comprises at least one resource allocation parameter. At operation 304, the apparatus 200 may perform resource allocation and MCS adaptation using the CQI/SINR/transmit buffer status for the entire duration of [symbol] seconds. This may mean that the apparatus may perform resource allocation and MCS adaptation for the future for all UEs 100 given the estimate of the at least one parameter. The obtained estimate of the at least one parameter may then be used by the network for pre-emptively scheduling resources to the UEs 100 both in UL and DL. Some of the fields in downlink control information (DCI) or PDCCH may be computed a priori using the estimate of the at least one parameter from the radio-aware digital twin 102. Such fields may be, but not limited to at least one of the following: an active bandwidth part scheduled to the UE 100, UL/DL frequency domain resource allocation, UL/DL time-domain resource allocation, MCS, and/or antenna port-related information.

At operation 305, the apparatus 200 may pick an arbitrary UE 100 with index ( [symbol] ,k). At operation 306, the apparatus 200 may obtain current link SINR/CQI for UE ( [symbol] ,k) from measurements or digital twin 102. At operation 308, optionally the apparatus may check if current link SINR may be good enough to transmit resource allocation configuration? If SINR/CQI may be greater than a predetermined threshold, the apparatus may transmit the resource allocation parameter set as an aggregate DCI or with some higher layer signalling. Else at operation 310, the apparatus 200 may transmit only the current resource allocation parameter set through a regular DCI over PDCCH, separately for each of the at least one time instant. After this, the apparatus may go back to operation 305 and pick different UE 100. The network may perform the optional operation of waiting for the UE's link SINR to be higher than the predetermined threshold to transmit the resource allocation configuration. This may allow the network to transmit a large resource allocation configuration at a higher MCS and a lower overhead than if the UE 100 had a poor link SINR. If the UE 100 has a poor link SINR, the network may choose to transmit a conventional PDCCH and delay putting the UE 100 on a resource allocation configuration until it moves to a location with better channel conditions.

If SINR/CQI may be greater than a predetermined threshold, the apparatus 200 may generate a resource allocation configuration comprising the at least one resource allocation parameter set associated with the at least one time instant t over the time interval T. At operation 312, it may generate frame numbers [symbol] and slot numbers [symbol] for UE ( [symbol] ,k) where resource allocation parameters need modification.

For each UE ( [symbol] , k) the apparatus may define N time instants [symbol] , [symbol] , . . . , [symbol] . It may also define frame and slot numbers [symbol] , [symbol] , . . . , [symbol] and [symbol] , [symbol] , . . . , [symbol] , respectively, corresponding to these N time instants, where some or all of the aforementioned fields in the DCI may be changed. At operation 314, for each slot [symbol] of frame [symbol] , the apparatus 200 may collect resource allocation parameters comprising at least one of the following: bandwidthPart, timeDomainResourceAllocation, frequency allocation, and/or MCS that need to be modified for UE ( [symbol] ,k).

At operation 316, for the picked UE ( [symbol] , k) at operation 305, the apparatus may generate resource allocation configuration for all the frames in the interval [0, [symbol] ] seconds. Operation 316 may populate the entries in the resource allocation configuration with the information in operations 312 and 314. Finally at operation 318, the apparatus 200 may transmit the resource allocation configuration to the picked UE 100

The apparatus 200 may generate a single PDCCH that may contain an aggregate of all the DCIs. The overhead from the resource allocation configuration may be further reduced by transmitting it at high MCS when the UE channel conditions are good. This is because the network may have the option of waiting to transmit the resource allocation configuration till the UE 100 moves to a location with good channel condition and may transmit the conventional PDCCH before that separately for each of the at least one time instant.

At operation 320, the apparatus may check if the resource allocation configuration has been transmitted to all UEs 100. If yes it will stop at operation 322. Else, the apparatus 100 may pick another UE 100 in operation 305 and repeat the rest of the process accordingly.

The resource allocation configuration may have signalling as follows:

```
Pdcch-config{
  numTotalParameterSet <number of resource allocation
  parameter sets in time-interval [0, [symbol]   ]>,// Begin re-
  source allocation configuration
      {
        // Set parameters at frame [symbol]   and slot [symbol]
        // corresponding to time instant [symbol]
        frameNumber <select frame [symbol]   >
        slotNumber <select slot [symbol]   in frame>
        bandwidthPart <value>,
        timeDomainResourceAllocation <value>,
        frequencyDomainAllocation <value>,
        MCS <value>,
        antennaPort <value>
    }
    {
        // Set parameters at frame [symbol]   and slot [symbol]
        //corresponding to time instant [symbol]
        frameNumber <select frame [symbol]   >
        slotNumber <select slot [symbol]   in frame>
        bandwidthPart <value>,
        timeDomainResourceAllocation <value>,
        frequencyDomainAllocation <value>,
        MCS <value>,
        antennaPort <value>
    }
    .
    .
    .
    {
        // Set parameters at frame [symbol]   and slot [symbol]
        //corresponding to time instant [symbol]
        frameNumber <select frame [symbol]   >
        slotNumber <select slot [symbol]   in frame>
        bandwidthPart <value>,
        timeDomainResourceAllocation <value>,
        frequencyDomainAllocation <value>,
        MCS <value>,
        antennaPort <value>
    }
    }
```

In the aforementioned resource allocation configuration, the ‘//’ indicate commented lines. The proposed single PDCCH may be targeted towards a certain UE 100 and may contain a field listing the duration of the resource allocation configuration in the number of frames. It may also contain changepoints [symbol] and [symbol] , where the time and frequency allocation, MCS and antenna port related information may be changed. In between the changepoints, the UE may continue the configuration that was given to it at the previous changepoint.

According to an example embodiment, if the environment is not “fully controlled”, for e.g. where there may by humans on the floor, the decision solely based on the digital twin 102 may not be the best one. In such cases, when the values of the local measurements such as COI or SINR made by the UE may differ from those predicted by the digital twin 102, the UE 100 may combine measurements obtained from local sensing, that are not available at the digital twin (on time), with the resource allocation configuration provided by the network. In other words, the network may also provide multiple choices of ranges of the at least one resource allocation parameter set in a resource allocation configuration or multiple resource allocation configurations to select from. According to an example embodiment, resource allocation configuration may comprise at least one default resource allocation parameter set and at least one alternative resource allocation parameter set. Each of the at least one default resource allocation parameter set and each of the at least one alternative resource allocation parameter set may be associated with corresponding one of the at least one time instant over the time interval. Each of the at least one default resource allocation parameter set may comprise the at least one resource allocation parameter, and each of the at least one alternative resource allocation parameter set may comprise the at least one resource allocation parameter. The UE 100 may select from the at least one default resource allocation parameter set and the at least one alternative resource allocation parameter set by combining locally available information with information from the digital twin 102. Such an approach may be result in the signalling being modified as follows:

At slot [symbol] , the network may instruct the UE to
Switch to BWP [symbol] and transmit on PRB [symbol] with power control coefficients [symbol] and [symbol] and MCS [symbol] if values of local measurements are within a predefined interval. This is a default option or comprised in the at least one default resource allocation parameter set.
If the values of the local measurements fall outside the predefined interval switch to BWP [symbol] and transmit on PRB [symbol] with, power control coefficients [symbol] and [symbol] and MCS [symbol] . This is the alternative option or comprised in the at least one alternative resource allocation parameter set; or
fall back to conventional PDCCH. This is a fallback option, wherein the at least one resource allocation parameter set may be transmitted separately at each of the at least one time instant t.

It is expected that the values of the local measurements may rarely fall outside the predefined interval and the UE may apply the at least one resource allocation parameter from the at least one alternative resource allocation parameter set or switch to fallback options rarely.

The local measurements at the UE may be obtained from demodulation reference symbols (DM-RS) within PDSCH data. The predefined interval may be obtained from the digital twin 102 as an estimate of the confidence interval on the parameters it outputs.

According to an example embodiment, the digital twin 102 may estimate the link SINR as SINR_{L}≤SINR≤SINR_{U}, with SINR_{L} and SINR_{U} as lower and upper bounds of the confidence interval. If the estimate of the link SINR is within these bounds at the UE 100, then it may use the default instructions given to it. However, if such an estimate is incorrect and the link SINR measured at the UE falls outside the predefined interval, the UE 100 may select the at least one alternative resource allocation parameter set instead of the at least one default resource allocation parameter set or the fallback option to the conventional PDCCH with several transmissions.

The UE 100 may need to notify the network of its choice if it selects the at least one alternative resource allocation parameter set/fallback options. Notification may be done through the physical random access channel (PRACH). PRACH may be expected to be fairly empty in a factory-type environment where the traffic may be predominantly machine-type with deterministic patterns. Furthermore, since it may be expected that the UE 100 may select the at least one alternative resource allocation parameter set/fallback options rarely, conveying this choice through the PRACH may be easy.

It is important that the selection of the at least one alternative resource allocation parameter set/fallback option for UE 100 may be a rare event, which necessitates the digital twin 102 that may be accurate for most of the time. Otherwise, if several UEs 100 may select the at least one alternative resource allocation parameter set/fallback options on a frequent basis, the PRACH may be crowded, and the UE 100 may not be able to convey its selection to the network in time.

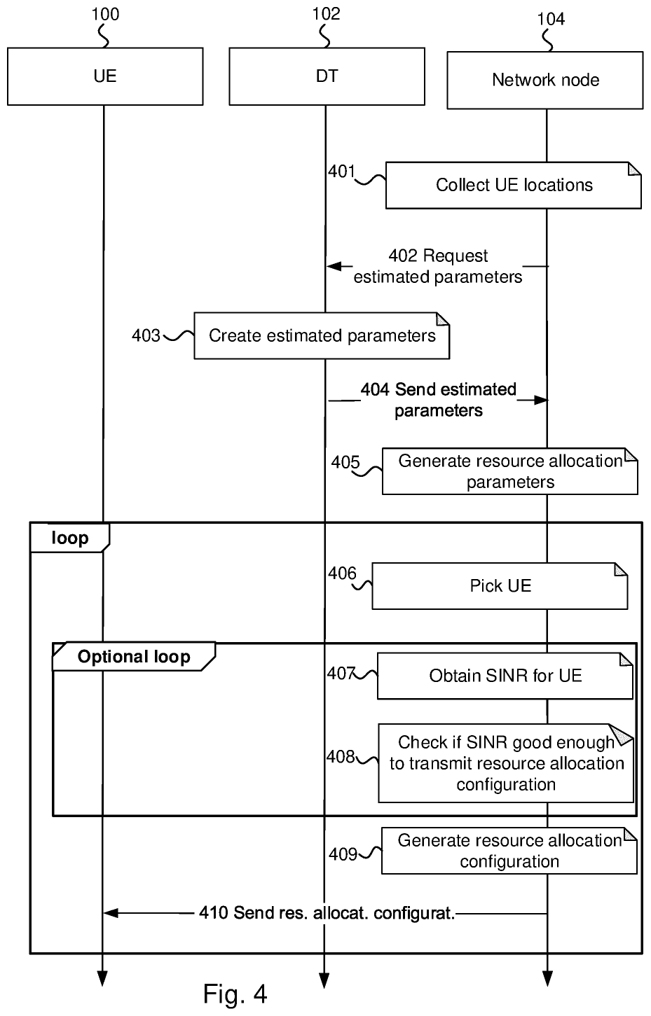

FIG. 4 illustrates an example of PDCCH signalling diagram incorporating aspects of the example embodiments. The signalling process may be performed as described with reference to FIG. 3. The process may be conducted between the UE 100, the digital twin 102, and the apparatus 200 such as a network node 104. The operations from 406, 409, and 410 may be performed within a closed loop. The operation 407 and 408 may be performed within a closed loop and may be optional.

At operation 401, the network node 104 may collect location information of at least one user device 100 at at least one time instant t over a time interval T.

At operation 402, the network node 104 may request an estimate of at least one parameter relating to the collected location information x at the at least one time instant t over the time interval T for each of the at least one user device 100 through a digital twin 102.

At operation 403, the digital twin 102 may create the estimate of at least one parameter and at operation 404 send it to the network node 104. The estimate of the at least one parameter may comprise at least one of the following: estimated channel statistics, channel quality indicator, signal to interference plus noise ratio, and/or transmit buffer status relating to the at least one time instant t over the time interval T for each of the at least one user device 100.

At operation 405, the network node 104 may generate at least one resource allocation parameter set each comprising at least one resource allocation parameter for each of the at least one user device 100 over the time interval T by using the obtained estimate of the at least one parameter, wherein the at least one resource allocation parameter set may be associated with corresponding one of the at least one time instant t. The at least one resource allocation parameter may comprise at least one of the following: an active bandwidth part, time allocation, frequency allocation, modulation and coding scheme, and/or antenna port related information. The network node 104 may generate the at least one resource allocation parameter set by performing resource allocation, and modulation and coding scheme adaptation over the time interval T by using the obtained estimate of the at least one parameter.

At operation 406, the network node 104 may start the loop for each of the at least one user device 100 by picking one user device 100.

At operation 409, the network node 104 may generate a resource allocation configuration comprising the at least one resource allocation parameter set associated with the corresponding one of the at least one time instant t over the time interval T. Generating the resource allocation configuration may comprise generating at least one frame F and a slot S within each of the at least one frame F for the at least one user device 100, the at least one frame F and the slot S within each of the at least one frame F may correspond to the at least one time instant t. Further, the network node 104 may collect the at least one resource allocation parameter set associated with the corresponding one of the at least one instant t over the time interval T and generate the resource allocation configuration comprising the at least one resource allocation parameter set associated with the corresponding one of the at least one time instant t over the time interval T.

At operation 410, the network node 104 may send the resource allocation configuration to the UE 100. If all UEs 100 have not received the resource allocation configuration yet, the network node 100 may select another UE 100 at operation 406 and continue the process until all the UEs 100 have received the resource allocation configuration.

As illustrated in FIG. 4, the loop may comprise a following optional functionality (“optional loop”) comprising operations 407 and 408.

At operation 407, the network node 104 may optionally obtain SINR or CQI from measurements or digital twin 102.

At operation 408, the network node 104 may check SINR or COI is good enough to transmit the resource allocation configuration. If the SINR or COI is higher than a predetermined threshold, the at least one resource allocation parameter set may be transmitted in the resource allocation configuration, and the process may continue at operations 409 and 410. If the SINR or CQI is equal or lower than the predetermined threshold, the at least one resource allocation parameter set may be transmitted separately for each of the at least one time instant t. This means that the network node 104 may wait for a good SINR or COI to transmit the resource allocation configuration and select another UE 100 at operation 406. The network node may continue the process at operation 406 and pick a new UE 100.

According to an example embodiment, putting the UEs 100 on a resource allocation configuration may reduce latency on the shared channels (PDSCH/PUSCH). Following factors may contribute it: lower transmission latency since the UE/network may not need to send/receive control signals; lower processing time since the UE 100 may need to perform PDCCH decode only once every T seconds, instead of a blind PDCCH decode every control resource set (CORESET); reduction in processing and compute time for operations that may react to the content of the PDCCH such as setting power levels, computing beamformer or combiner, etc.

According to an example embodiment, latency reduction may be an advantage in narrow-band UEs because a narrow-band UE 100 may have to use multiple OFDM symbols (up to 3 OFDM symbols in 5G NR) to receive PDCCH since the reception bandwidth is limited. Frequent PDCCH transmissions may further increase the overall transmission latency for such UEs 100 especially in the case where several narrow-band UEs 100 need to be served. Combining several PDCCH transmissions may reduce this latency.

According to an example embodiment, improved spectral efficiency on the control channels may be another advantage. This may be because transmitting a long resource allocation configuration may benefit from the following:
Efficient PDCCH link adaptation (modulation scheme, code rate, and aggregation levels (AL), if channel conditions at the UE 100 may be known a priori. The network may also decide to transmit the resource allocation configuration when the channel conditions to the UE 100 are good.
Combining DCI from many PDCCH may increase the codeword length, improving error correction performance since forward error correction (FEC) performance improves with codeword length.
Data compression if the payload bits across several PDCCH transmissions may be correlated.
Lower cyclic redundancy check (CRC) overhead: 5G-NR may use a 24-bit CRC with each PDCCH transmission. Clubbing N PDCCH transmissions into a single transmission may result in savings of (N−1)×24 bits.
Lower PDCCH DM-RS overhead: Each PDCCH transmission may have a 25 percent overhead for transmitting the PDCCH DM-RS, that may be reduced by aggregating several PDCCH transmissions. In addition, the density of the DM-RS pilots in time may depend on the doppler spread and in frequency, it may depend on the channel spread. If the channel or doppler spread at the UE is small and is known to the digital twin 102, the network may transmit fewer DM-RS per resource element group (REG) and further reduce this overhead.

Without in any way limiting the scope, interpretation, or application of the claims appearing below, a technical effect of one or more of the example embodiments disclosed herein is that network spectral efficiency may increase and latency may reduce.

Putting UEs on a resource allocation configuration through the digital twin 102 may also minimize overhead from measurement-related signalling such as SRS. SRS may be used primarily for measuring channel quality for scheduling and resource allocation. The digital twin 102 may enable putting UEs 100 on a resource allocation configuration where the resource allocations may be performed without the overhead associated with this signalling.

According to an example embodiment, the following example may illustrate the potential reduction in overhead when using a slim PDCCH with a digital twin 102 such as a radio-aware digital twin. A 5G NR network may communicate with a UE 100 over a TDD link with 30 kHz subcarrier spacing. The UE 100 may have up-to 3 BWPs, each with a 10 MHz bandwidth. Each UL slot may be followed by 3 DL slots. Each DL slot may have a PDCCH and each UL slot as an SRS that is of 2 OFDM symbol duration. The PDCCH (AL) may be either 1, 4, 8, or 16.

In the following, one practical example for a better understanding of the examples will be given in a table 1.

TABLE 1
information from the overhead from PDCCH and SRS.

| AL = 1 | AL = 4 | AL = 8 | AL = 16 |
|---|---|---|---|
| Overhead - | Overhead - | Overhead - | Overhead - |
| 4.9% | 8.9% | 14.28% | 25% |

Next, the overhead may be computed when the UEs 100 are put on a resource allocation configuration. For this, the digital twin 102, may provide accurate channel and link conditions for the next 10 ms (the duration of a 5G NR frame) and so, the use of an SRS symbol in each UL slot is unnecessary.

To maintain fairness in the comparison, N may be equal to the number of DL slots in the 5G NR frame and the time instants t₀, . . . , t_{N-1} point to the beginning of each DL slot. A 100 bit DCI may need to be transmitted in each DL slot. The aggregate of N DCIs may be encoded using a rate 1/3 code and 16-QAM modulated, assuming that the UE may have good link conditions. At this case, the PDCCH overhead with the resource allocation configuration may be 1.4% implying a 3.5× to 7× reduction in the PDCCH overhead.

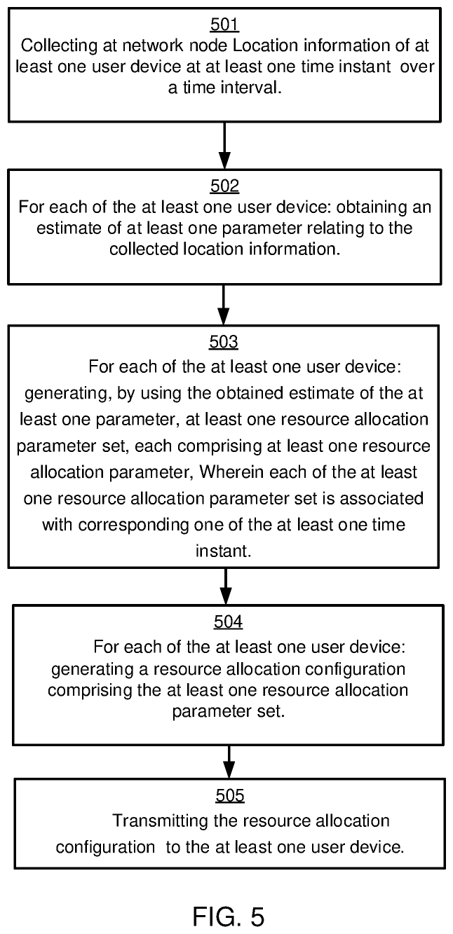

FIG. 5 illustrates an example method according to an example embodiment.

At operation 501, the method may comprise collecting at a network node location, information of at least one user device 100 at at least one time instant t over a time interval T.

At operation 502, the method may comprise for each of the at least one user device: obtaining an estimate of at least one parameter relating to the collected location information.

At operation 503, for each of the at least one user device: the method may comprise generating, by using the obtained estimate of the at least one parameter, at least one resource allocation parameter set each may comprise at least one resource allocation parameter, wherein each of the at least one resource allocation parameter set may be associated with corresponding one of the at least one time instant.

At operation 504, the method may comprise, for each of the at least one user device: generating a resource allocation configuration comprising the at least one resource allocation parameter set.

At operation 505, the method may comprise transmitting the resource allocation configuration to the at least one user device 100.

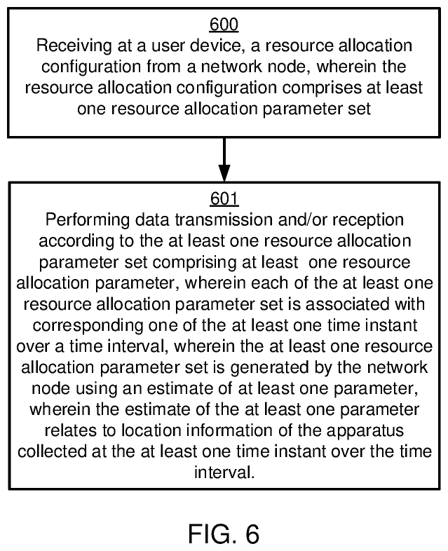

FIG. 6 illustrates another example method according to an example embodiment.

At operation 600, the method may comprise receiving at a user device 100, a resource allocation configuration from a network node 104. The resource allocation configuration may comprise at least one resource allocation parameter set.

At operation 601, the method may comprise performing data transmission and/or reception according to the at least one default resource allocation parameter, wherein each of the at least one resource allocation parameter set may be associated with corresponding one of the at least one time instant over a time interval. The at least one resource allocation parameter set may have been generated by the network node 104 using an estimate of at least one parameter. The estimate of the at least one parameter may relate to location information of the apparatus 200 collected at the at least one time instant over the time interval.

Further features of the methods in FIGS. 5 and 6 may directly result for example from the functionalities and parameters of the apparatus 100, the digital twin 102, or the network node 104, as described in the appended claims and throughout the specification and are therefore not repeated here. Different variations of the methods may be also applied, as described in connection with the various example embodiments.

An apparatus, for example a network node or user device, may be configured to perform or cause performance of any aspect of the methods described herein. Further, a computer program may comprise instructions for causing, when executed, an apparatus to perform any aspect of the methods described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including computer program code, the at least one memory and the computer code configured to, with the at least one processor, cause the apparatus at least to:
collect location information of at least one user device at at least one time instant over a time interval;
for each of the at least one user device,
obtain an estimate of at least one parameter relating to the collected location information;
generate, by using the obtained estimate of the at least one parameter, at least one resource allocation parameter set each comprising at least one resource allocation parameter, wherein each of the at least one resource allocation parameter set is associated with corresponding one of the at least one time instant;
generate a resource allocation configuration comprising the at least one resource allocation parameter set; and
transmit the resource allocation configuration to the at least one user device.

2. The apparatus according to claim 1, wherein the at least one memory and the computer code are further configured to, with the at least one processor, cause the apparatus to:
generate the at least one resource allocation parameter set by assigning resource allocation, and modulation and coding scheme adaptation over the time interval based at least on the obtained estimate of the at least one parameter.

3. The apparatus according to claim 1, wherein the resource allocation configuration comprises a frame number and/or a slot number corresponding to each of the at least one time instant.

4. The apparatus according to claim 1, wherein the at least one resource allocation parameter comprises at least one of the following: an active bandwidth part, time allocation, frequency allocation, modulation and coding scheme, and/or antenna port related information.

5. The apparatus according to claim 1, wherein the at least one memory and the computer code are further configured to, with the at least one processor, cause the apparatus to:
for each of the at least one user device,
obtain link signal to interference plus noise ratio and/or channel quality indicator from measurements or the digital twin;
if the link signal to interference plus noise ratio and/or the channel quality indicator is higher than a predetermined threshold, transmit the at least one resource allocation parameter set in the resource allocation configuration; and
if the link signal to interference plus noise ratio and/or the channel quality indicator is equal or lower than the predetermined threshold, transmit the at least one resource allocation parameter set separately for each of the at least one time instant.

6. The apparatus according to claim 1, wherein the estimate of the at least one parameter is obtained using a digital twin.

7. The apparatus according to claim 1, wherein the resource allocation configuration comprises at least one default resource allocation parameter set and at least one alternative resource allocation parameter set,
wherein each of the at least one default resource allocation parameter set and each of the at least one alternative resource allocation parameter set are associated with the corresponding one of the at least one time instant over the time interval, each of the at least one default resource allocation parameter set comprises the at least one resource allocation parameter, and each of the at least one alternative resource allocation parameter set comprises the at least one resource allocation parameter.

8. The apparatus according to claim 7, wherein the resource allocation configuration comprises instructions indicating the at least one user device to:
if values of local measurements at the at least one user device are within a predefined interval,
perform data transmission and/or reception according to the at least one default resource allocation parameter set; and
if the values of the local measurements at the at least one user device are outside the predefined interval,
perform the data transmission and/or reception according to the at least one alternative resource allocation parameter set; or
receive the at least one resource allocation parameter set separately at each of the at least one time instant.

9. The apparatus according to claim 8, wherein the local measurements are obtained by the at least one user device over demodulation reference symbols within data transmitted in a physical downlink shared channel.

10. The apparatus according to claim 8, wherein the predefined interval is obtained from the digital twin as an estimate of a confidence interval on the obtained estimate of the at least one parameter.

11. The apparatus according to claim 1, wherein the obtained estimate of the at least one parameter comprising at least one of the following: estimated channel statistics, channel quality indicator, signal to interference plus noise ratio, and/or transmit buffer status relating to the at least one time instant over the time interval for each of the at least one user device.

12. The apparatus according to claim 6, wherein the digital twin is a radio-aware digital twin.

13. The apparatus according to claim 1, wherein the at least one resource allocation parameter set corresponding to each of the at least one time instant is different.

14. The apparatus according to claim 1, wherein the resource allocation configuration is transmitted to the at least one user device as an aggregate downlink control information or with higher layer signalling.

15. An apparatus, comprising:
at least one processor; and
at least one memory including computer program code, the at least one memory and the computer code configured to, with the at least one processor, cause the apparatus at least to:
receive a resource allocation configuration from a network node, wherein the resource allocation configuration comprises at least one resource allocation parameter set; and
perform data transmission and/or reception according to the at least one resource allocation parameter set comprising at least one resource allocation parameter, wherein each of the at least one resource allocation parameter set is associated with corresponding one of at least one time instant over a time interval,
wherein the at least one resource allocation parameter set is generated by the network node using an estimate of at least one parameter, wherein the estimate of the at least one parameter relates to location information of the apparatus collected at the at least one time instant over the time interval.

16. The apparatus according to claim 15, wherein the resource allocation configuration comprises at least one default resource allocation parameter set and at least one alternative resource allocation parameter set,
wherein each of the at least one default resource allocation parameter set and each of the at least one alternative resource allocation parameter set are associated with the corresponding one of the at least one time instant over the time interval, each of the at least one default resource allocation parameter set comprises the at least one resource allocation parameter, and each of the at least one alternative resource allocation parameter set comprises the at least one resource allocation parameter.

17. The apparatus according to claim 16, wherein the resource allocation configuration further comprises instructions indicating the apparatus to:
if values of local measurements at the apparatus are within a predefined interval,
perform the data transmission and/or reception according to the at least one default resource allocation parameter set; and
if the values of the local measurements at the apparatus are outside the predefined interval,
perform the data transmission and/or reception according to the at least one alternative resource allocation parameter set; or
receive the at least one resource allocation parameter set separately at each of the at least one time instant.

18. The apparatus according to claim 17, wherein the local measurements are obtained over demodulation reference symbols within data transmitted in a physical downlink shared channel.

19-22. (canceled)

23. A method comprising:
collecting at a network node, location information of at least one user device at at least one time instant over a time interval;
for each of the at least one user device,
obtaining an estimate of at least one parameter relating to the collected location information;
generating, by using the obtained estimate of the at least one parameter, at least one resource allocation parameter set each comprising at least one resource allocation parameter, wherein each of the at least one resource allocation parameter set is associated with corresponding one of the at least one time instant;
generating a resource allocation configuration comprising the at least one resource allocation parameter set; and
transmitting the resource allocation configuration to the at least one user device.

24-36. (canceled)

37. A method comprising:
receiving at a user device, a resource allocation configuration from a network node, wherein the resource allocation configuration comprises at least one resource allocation parameter set; and
performing data transmission and/or reception according to the at least one resource allocation parameter set comprising at least one resource allocation parameter, wherein each of the at least one resource allocation parameter set is associated with corresponding one of the at least one time instant over a time interval,
wherein the at least one resource allocation parameter set is generated by the network node using an estimate of at least one parameter, wherein the estimate of the at least one parameter relates to location information of the apparatus collected at the at least one time instant over the time interval.

38-48. (canceled)
